(19) United States
(12) Patent Application Publication
(10) Pub. No.: US 2011/0111121 A1
(43) Pub. Date: May 12, 2011

(54) THIN FILM FORMING METHOD AND FILM FORMING APPARATUS

(75) Inventors: Kazuyoshi Honda, Osaka (JP); Yuma Kamiyama, Kyoto (JP); Yasuharu Shinokawa, Osaka (JP); Masahiro Yamamoto, Osaka (JP)

(73) Assignee: PANASONIC CORPORATION, Kadoma-shi, Osaka (JP)

(21) Appl. No.: 12/866,434

(22) PCT Filed: Feb. 10, 2009
(86) PCT No.: PCT/JP2009/000530

§ 371 Date: Aug. 5, 2010

(30) Foreign Application Priority Data
Feb. 15, 2008 (JP) 2008-034131

(51) Int. Cl. B05D 1/12; B29C 41/28

(52) U.S. Cl. 427/180; 264/482; 425/115

(57) ABSTRACT

The present invention relates to a method of forming a thin film by depositing, in a vacuum, particles emitted from a film forming source (27) on a substrate (21). Specifically, the particles are deposited on the substrate (21) in a state where a movable endless belt (11) is disposed between the film forming source (27) and the substrate (21) so that a film forming area DA is defined on a surface of the substrate (21) by the endless belt (11), whose moving path has a forward path and a return path that are formed between the film forming source (27) and the substrate (21). Typically, the substrate (21) is an elongated substrate having flexibility. The particles are deposited on the substrate (21) that is being transferred from a feed roller (23) to a take-up roller (26).

### TECHNICAL FIELD

The present invention relates to a thin film forming method and a film forming apparatus.

### BACKGROUND ART

Recently, thin film techniques have been used widely to enhance the performance of devices and to reduce the size thereof. Thin film devices not only provide direct benefits to users but also play an important role in environmental aspects such as protection of earth resources and reduction in power consumption.

Generally, in a vacuum film formation process, a film forming source and a substrate are disposed to face each other and a film forming area on the surface of the substrate is defined by a mask. In some cases, only the particles incident on the substrate at a specific range of angles, among the particles emitted from the film forming source, are deposited on the substrate.

Long-time film formation techniques are essential to increase the productivity of thin films. Not only the techniques for stabilizing the film forming source for a long time and for transferring the substrate but also the measures to prevent deposits from forming around the substrate are important keys to the achievement of the long time film formation.

In the long-time film formation process, the material is deposited increasingly on the mask as the film forming time passes, which increases the possibility that the film forming area (size and shape) may change or the deposit may fall on the substrate or the film forming source. If the film forming area changes, a thin film as designed cannot be formed. If the deposit falls on the film forming source, the rapid temperature change in the film forming source may cause a decrease in the evaporation rate of the material, or the splashing of the material may form an undesirable projection on the thin film.

To solve these problems, conventionally, a deposition-preventing plate is disposed between the substrate and the film forming source, in addition to the mask. The deposition-preventing plate is required to serve to make the cleaning of the vacuum chamber more efficient, to prevent the deposit from falling on the substrate, to enhance the use efficiency of the material, etc.

For example, JP 05 (1993)-222520 A discloses a technique in which a take-up deposition preventing plate is moved along the inner wall of a vacuum chamber so as to prevent the deposition of a material on the inner wall of the vacuum chamber.

JP 06 (1994)-228751 A discloses a technique in which a mask for intercepting a part of a vapor stream moving from an evaporation source toward a substrate and a take-up deposition preventing plate for preventing the deposition of a material on the mask are provided so as to prevent the material deposited on the deposition preventing plate from falling on the substrate.

JP 62 (1987)-218557 A discloses a technique in which a coated film of alumina or silica is formed on the surface of a deposition preventing plate so as to prevent a material deposited on the deposition preventing plate from falling off the deposition preventing plate.

JP 58(1983)-64382 A discloses a technique in which a material deposited on a chain-driven deposition preventing plate is recovered, re-melted, and evaporated so as to enhance the use efficiency of the material.

JP 10(1998)-287967 A discloses a technique in which a deposition preventing plate and a deposition preventing tape are formed of the same material as a vapor deposition material, and the material deposited on the deposition preventing plate and the deposition preventing tape is recovered together with these deposition preventing plate and the deposition preventing tape so as to reuse the recovered material as the vapor deposition material and to enhance the use efficiency of the material.

### DISCLOSURE OF THE INVENTION

As described in the above documents, the use of a take-up deposition preventing plate such as a deposition preventing tape prevents the deposit from growing to be thick on the deposition preventing plate. However, even if the techniques described in the above documents are used, the deposition of the material on the mask cannot always be prevented completely. Particularly, it is difficult to prevent the material from being deposited on the edge portion of the mask. When a large amount of material is deposited on the edge portion of the mask, the film forming area and the incident angle range of the material particles change, which makes it impossible to manufacture a thin film as designed. It is an object of the present invention to provide a useful technique for performing long-time film formation stably and accurately.

The present invention provides a method of forming a thin film by depositing, in a vacuum, particles emitted from a film forming source on a substrate. The method includes a step of depositing the particles on the substrate in a state where a movable endless belt is disposed between the film forming source and the substrate so that a film forming area is defined on a surface of the substrate by the endless belt, whose moving path has a forward path and a return path that are formed between the film forming source and the substrate.

In another aspect, the present invention provides a film forming apparatus including: a vacuum chamber; a film forming source placed in the vacuum chamber; a substrate transfer unit for feeding a substrate to a predetermined film forming position that faces the film forming source; and a movable shielding mechanism having an endless belt for defining a film forming area on a surface of the substrate, and a driving section for moving the endless belt so that a portion of the endless belt that defines the film forming area shifts from one to another. The endless belt is placed in proximity to the film forming position so that a forward path and a return path of a moving path of the endless belt are formed between the film forming position and the film forming source.

According to the method and apparatus of the present invention, the movable endless belt serves as a mask that defines the film forming area. The moving of the endless belt prevents the material from being deposited locally on a particular portion of the endless belt. Therefore, the film forming area and the incident angle range of the material particles can be maintained constant during the long-time film formation process, and consequently a thin film as designed can be manufactured stably. In addition, the use of the endless belt reduces the apparatus cost. Furthermore, when the forward and return paths of the moving path of the endless belt are formed between the film forming position and the film forming source, the substrate is shielded doubly by the endless belt. In this case, the portion of the endless belt that occupies one of these paths located farther from the substrate can protect the portion that occupies the other path located closer to the substrate, from the radiant heat and the material particles (the self-protection effect of the endless belt). Accordingly, the portion that occupies the path located closer to the substrate can define the film forming area accurately over a long period of time.

### BRIEF DESCRIPTION OF DRAWINGS

FIG. 1 is a schematic cross-sectional view of a film forming apparatus according to an embodiment of the present invention.

FIG. 2A is a bottom view showing the positional relationship among a substrate, an endless belt, and a fixed shielding plate.

FIG. 2B is a bottom view showing a modification in which all masks are formed of endless belts.

FIG. 3A is a schematic cross-sectional view of a shielding unit provided in the film forming apparatus shown in FIG. 1, taken along a line III-III therein.

FIG. 3B is a partially perspective view of the film forming apparatus shown in FIG. 1.

FIG. 4 is a schematic cross-sectional view of a shielding unit having a release agent applicator.

FIG. 5 is a schematic cross-sectional view of a modified cleaner for removing deposits on the endless belt.

FIG. 6 is a schematic cross-sectional view of another modified cleaner for removing deposits on the endless belt.

FIG. 7 is a schematic cross-sectional view of a modified film forming apparatus.

### BEST MODE FOR CARRYING OUT THE INVENTION

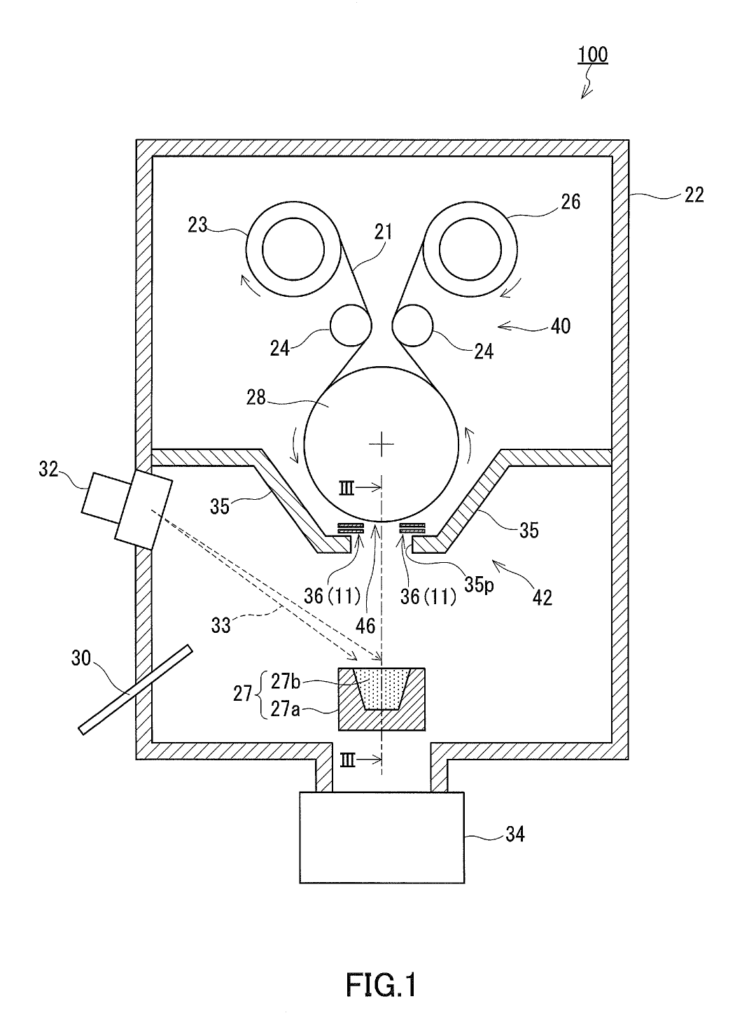

Hereinafter, embodiments of the present invention will be described with reference to the accompanying drawings. As shown in FIG. 1, a film forming apparatus 100 of the present embodiment includes a vacuum chamber 22, a substrate transfer unit 40, a shielding unit 42, and a film forming source 27. The substrate transfer unit 40, the shielding unit 42 and the film forming source 27 are placed in the vacuum chamber 22. A vacuum pump 34 is connected to the vacuum chamber 22. An electron gun 32 and a source gas inlet 30 are provided on the side wall of the vacuum chamber 22.

The shielding unit 42 is disposed between the film forming source 27 and the substrate transfer unit 40 so as to define the film forming area on the surface of the substrate 21. The shielding unit 42 is composed of a fixed shielding plate 35 and a movable shielding mechanism 36.

The fixed shielding plate 35 is mounted in the vacuum chamber 22. The fixed shielding plate 35 also is provided in the direction perpendicular to the paper surface of FIG. 1. During the film formation process, the relative positional relationship among the film forming source 27, the fixed shielding plate 35, and the substrate transfer unit 40 is not changed. The fixed shielding plate 35 partitions the inside of the vacuum chamber 22 into the side in which the substrate transfer unit 40 is placed and the side in which the film forming source 27 is placed. The fixed shielding plate 35 has an opening 35p, through which the material particles can travel from the film forming source 27 toward the substrate 21.

The movable shielding mechanism 36 has a movable endless belt 11 that shields the substrate 21. In the present embodiment, the endless belts 11 are disposed respectively on the upstream side and the downstream side of the transfer direction of the substrate 21. Each of the endless belts 11 is disposed in a position where the endless belt 11 faces the opening 35p of the fixed shielding plate 35. More specifically, part of the endless belt 11 faces the opening 35p and the remaining part thereof overlaps the fixed shielding plate 35 in the thickness direction of the endless belt 11. The endless belts 11 are located closer to the substrate 21 than the fixed shielding plate 35.

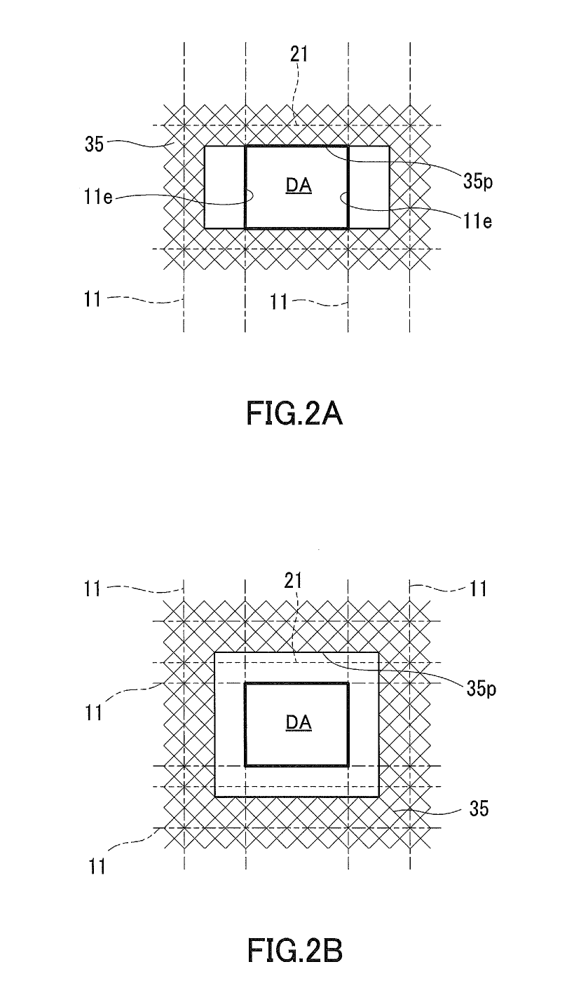

As shown in the bottom view of FIG. 2A, viewed vertically upward from the film forming source 27, a rectangular film forming area DA is defined by the side edges 11e of the endless belts 11 and the opening 35p of the fixed shielding plate 35. A pair of opposite sides of the film forming area DA are defined by the side edges 11e of the endless belts 11, and the other pair of opposite sides are defined by the opening 35p of the fixed shielding plate 35. In this manner, both of the endless belts 11 and the fixed shielding plate 35 serve as masks. The film forming area DA on the surface of the substrate 21 is an area that faces the opening 35p of the fixed shielding plate 35 and is not shielded by the endless belts 11. In other words, the film forming area DA means an area on the substrate 21 the material particles from the film forming source 27 can reach.

As shown in FIG. 1, the substrate transfer unit 40 has a function of feeding the substrate 21 to a predetermined film forming position 46 that faces the film forming source 27, and a function of retracting, from the film forming position 46, the substrate 21 on which a film has been formed. The film forming position 46 is a position on the transfer path of the substrate 21. When the substrate 21 passes through this film forming position 46, the material 27b emitted from the film forming source 27 is deposited on the substrate 21, so that a thin film is formed on the substrate 21.

Specifically, the substrate transfer unit 40 is composed of a feed roller (first roller) 23, guide rollers 24, a can 28, and a take-up roller (second roller) 26. The substrate on which a film is to be formed is put on the feed roller 23. The guide rollers 24 are disposed respectively on the upstream side and the downstream side of the transfer direction of the substrate 21. The guide roller 24 on the upstream side guides the substrate 21 fed from the feed roller 23 to the can 28. The can 28 supports and guides the substrate 21 to the film forming position 46, and then guides the substrate 21, on which a film has been formed, to the guide roller 24 on the downstream side. The can 28 also has a function of cooling the substrate 21 on which the film has been formed. The guide roller 24 on the downstream side guides the substrate 21, on which the film has been formed, to the take-up roller 26. The take-up roller 26 is driven by a motor (not shown), and takes up and holds the substrate 21 on which the thin film has been formed.

During the film formation process, the operation of feeding the substrate 21 from the feed roller 23 and the operation of taking up the substrate 21, on which the film has been formed, along the take-up roller 26 are performed in synchronization with each other. That is, the film forming apparatus 100 is a so-called take-up film forming apparatus for forming a thin film on the substrate 21 that is being transferred from the feed roller 23 toward the take-up roller 26. When such a take-up film forming apparatus is used, high productivity can be expected because a long-time film formation can be performed, but it is even more important to take measures against the formation of deposits on the portions other than the substrate. Therefore, if the present invention is applied to a take-up film forming apparatus, a higher effect can be expected. The application of the present invention is not, however, limited to a take-up film forming apparatus. For example, the present invention also can be applied to a load lock type film forming apparatus for feeding substrates one by one to a film forming position.

In the present embodiment, the substrate 21 is an elongated substrate having flexibility. The material of the substrate 21 is not particularly limited. A polymer film or a metal foil can be used. Examples of the polymer film include a polyethylene terephthalate film, a polyethylene naphthalate film, a polyamide film, and a polyimide film. Examples of the metal foil include an aluminum foil, a copper foil, a nickel foil, a titanium foil, and a stainless steel foil. A composite of a polymer film and a metal foil also can be used for the substrate 21.

The dimensions of the substrate 21 also are not particularly limited because they are determined according to the type of thin films to be manufactured and the production volume of the films. The width of the substrate 21 is, for example, 50 to 1000 mm, and the thickness of the substrate 21 is, for example, 3 to 150 μm.

During the film formation process, the substrate 21 is transferred at a constant speed. The transfer speed is, for example, 0.1 to 500 m/min, although it varies depending on the type of thin films to be manufactured and the film forming conditions. An appropriate tension is applied to the substrate 21 that is being transferred, depending on the material of the substrate 21, the dimensions of the substrate 21, the film forming conditions, etc. The substrate 21 may be transferred intermittently to form a thin film on the substrate 21 in resting state.

The film forming source 27 is an evaporation source configured to heat the material 27b in a crucible 27a by an electron beam 33 from an electron gun 32. That is, the film forming apparatus 100 is a vacuum vapor deposition apparatus. The film forming source 27 is placed in the lower part of the vacuum chamber 22 so that the evaporated material 27b travels vertically upward. Other heating techniques such as resistance heating and induction heating may be used instead of an electron beam.

The opening of the crucible 27a is, for example, circular, oval, rectangular, or toroidal in shape. During a continuous vacuum vapor deposition process, it is effective for the uniformity of the widthwise film thickness to use the crucible 27a having a rectangular opening wider than the width of a film to be formed. As a material for the crucible 27a, a metal, an oxide, a refractory material, or the like can be used. Examples of the metal include copper, molybdenum, tantalum, tungsten, and alloys containing these metals. Examples of the oxide include alumina, magnesia, and calcia. Examples of the refractory material include boron nitride and carbon. The crucible 27a may be water-cooled.

The source gas inlet 30 extends from the outside to the inside of the vacuum chamber 22. One end of the source gas inlet 30 is directed to the space between the film forming source 27 and the substrate 21. The other end of the source gas inlet 30 is connected to a source gas supplier (such as a gas cylinder and a gas generating apparatus) placed outside the vacuum chamber 22. When an oxygen gas or a nitrogen gas is fed into the vacuum chamber 22 through the source gas inlet 30, a thin film containing, as a main component, an oxide, a nitride, or an oxynitride of the material 27b in the crucible 27a can be formed.

During the film formation process, the vacuum pump 34 is used to maintain the inside of the vacuum chamber 22 at a pressure (for example, 1.0×10⁻² to 1.0×10⁻⁴ Pa) suitable for forming a thin film. As the vacuum pump 34, various types of vacuum pumps such as a rotary pump, an oil diffusion pump, a cryopump, and a turbomolecular pump.

As the film forming source 27, other film forming sources such as an ion plating source, a sputtering source, a CVD source, and a plasma source may be used. A combination of a plurality of film forming sources also may be used.

Next, the shielding unit 42 is described in detail.

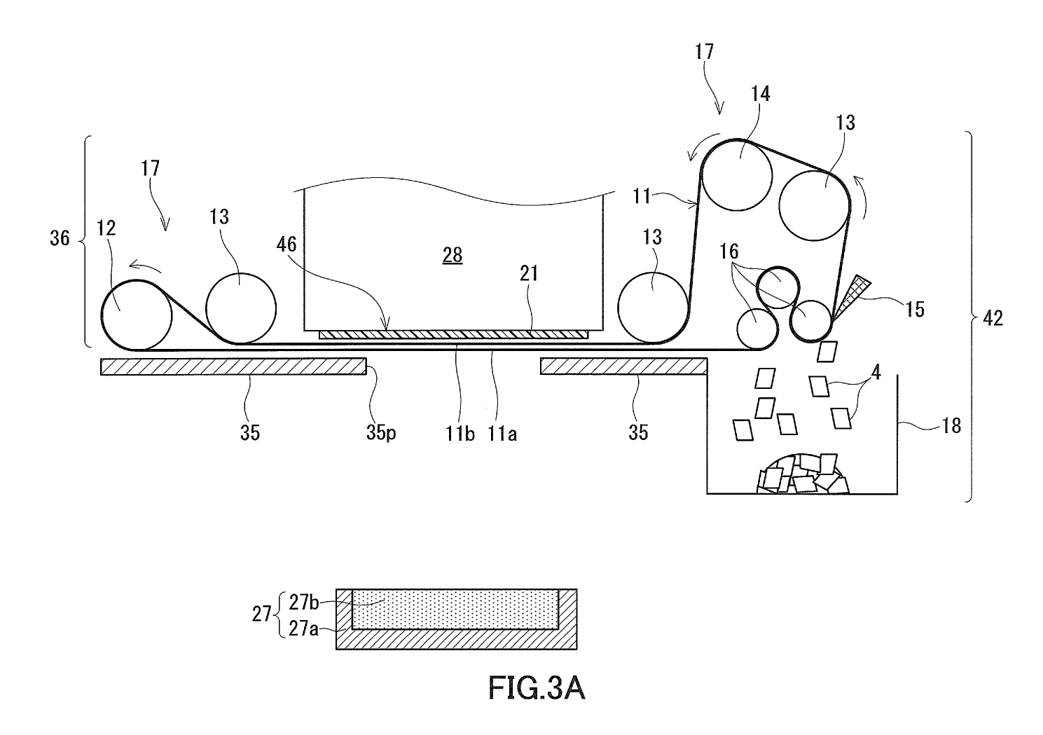

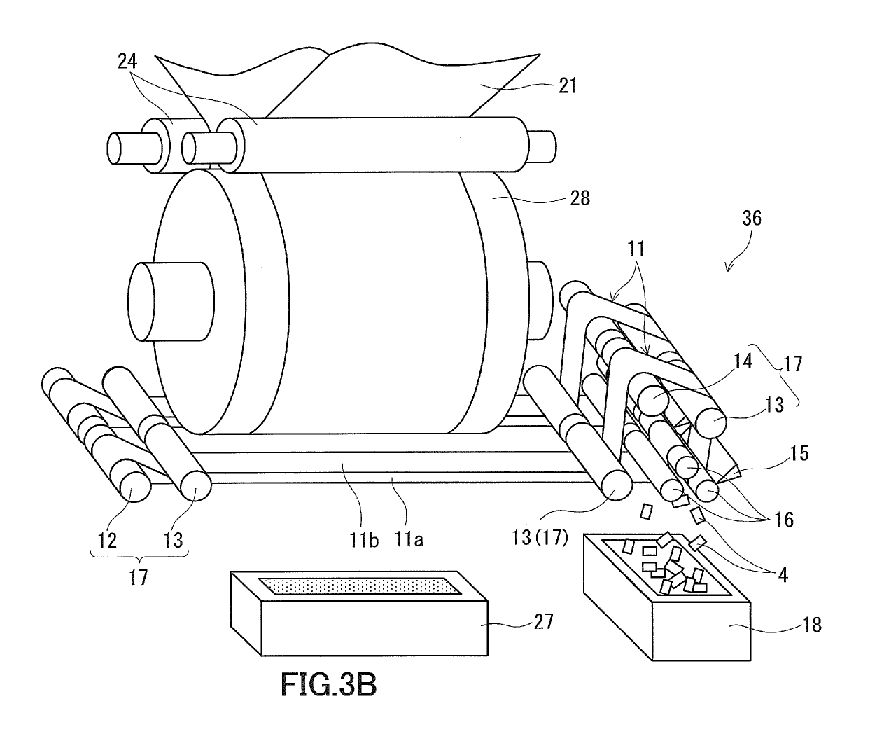

FIG. 3A is a schematic cross-sectional view of the shielding unit 42 provided in the film forming apparatus 100, taken along a line III-III. The direction perpendicular to the paper surface of FIG. 3A is the rotation direction of the can 28. FIG. 3B is a partially perspective view of the main part of the film forming apparatus 100. To facilitate understanding, the fixed shielding plate 35 is not shown in FIG. 3B. The movable shielding mechanism 36 of the shielding unit 42 has the endless belts 11 for defining the film forming area DA (see FIG. 2A) on the surface of the substrate 21, and the driving section 17 for moving the endless belts 11.

Each of the endless belts 11 is disposed between the film forming position 46 and the film forming source 27 and in proximity to the film forming position 46. The driving section 17 moves the endless belt 11 so that the portion of the endless belt 11 that defines the film forming area DA (the portion that shields the substrate 21) shifts from one to another. When the endless belt 11 is moved so that the portion thereof that defines the film forming area DA shifts from one to another, it is possible to prevent the material 27b from being deposited locally on a particular portion of the endless belt 11 as a mask. That is, the change (in the size and shape) of the film forming area DA can be prevented. The moving of the endless belt 11 also prevents the endless belt 11 itself from being deformed by heat. As a result, the change of the film forming area DA caused by the deformation of the endless belt 11 can be prevented. Since the endless belt 11 can be moved without purging the vacuum chamber 22, high productivity can be maintained.

The driving section 17 has a plurality of rollers 12 to 14 around which the endless belt 11 is wound. The rollers 12 to 14 are disposed in positions away from the position for shielding the substrate 21, and reverse the moving direction of the endless belt 11 on both sides in the transverse direction of the substrate 21 (the width direction of the elongated substrate 21). The endless belt 11 is supported by the rollers 12 to 14 on the inner and outer surfaces of the belt, and is moved along the rollers 12 to 14. In the present embodiment, the rollers 12 to 14 include a driving roller 12, transfer rollers 13, and a tension roller 14.

The driving roller 12 is a roller for applying a driving force to the endless belt 11. When the driving roller 12 is placed in contact with the inner surface of the endless belt 11, the driving roller 12 is less likely to be affected by the deposits formed on the endless belt 11. Therefore, such placement is effective for the stable movement of the endless belt 11. The driving roller 12 typically is made of a metal such as stainless steel. The surface of the driving roller 12 may be coated with a film, for example, a hard chromium plating, to increase the durability. To ensure that a driving force is applied to the endless belt 11, the surface of the driving roller 12 may be lined with a resin, for example, rubber, or may be subjected to a surface treatment such as embossing.

The transfer rollers 13 are freely rotatable rollers. A plurality of transfer rollers 13 are provided on the moving path of the endless belt 11. A part or all of the transfer rollers 13 may be replaced by the driving rollers 12, if necessary.

The tension roller 14 is a roller for applying a tension to the endless belt 11. When the tension roller 14 applies a tension to the endless belt 11, the driving force of the driving roller 12 is applied to the endless belt 11 without fail. Therefore, the endless belt 11 moves stably along the moving path. Examples of the tension applying mechanism of the tension roller 14 include mechanisms using a spring, using a pneumatic actuator or a hydraulic actuator, and applying an electromagnetic force thereto.

The rollers 12 to 14 may be cooled. During the film formation process, the endless belt 11 is heated by the heat of the material particles and the radiant heat from the film forming source 27. When the rollers 12 to 14 are cooled, the endless belt 11 can be cooled intentionally through the rollers 12 to 14. As a result, the damage or deformation of the endless belt 11 by heat can be prevented reliably.

The diameters of the respective rollers 12 to 14 are determined appropriately according to the size of the entire shielding unit 42, the dimensions of the endless belt 11, etc. The diameters of the respective rollers 12 to 14 typically are in the range of 25 to 300 mm. When the rollers having these diameters are used, the endless belt 11 is bent smoothly along the rollers 12 to 14. As a result, the endless belt 11 can move smoothly. Furthermore, the rollers 12 to 14 do not occupy an excessively large space in the vacuum chamber 22.

A metal belt or a resin belt can be used as the endless belt 11. It is desirable that the resin belt be made of a heat-resistant resin such as polyamide or polyimide. A metal belt is suitable as the endless belt 11 because it generally has higher heat resistance and strength than a resin belt. The material of the metal belt is not particularly limited. Iron, copper, nickel, titanium, stainless steel, etc. are desirable in terms of handleability, flexibility, and cost.

The dimensions of the endless belt 11 are determined appropriately according to the film forming conditions such as a film forming material and a film forming rate. The thickness of the endless belt 11 is, for example, about 20 to 300 μm. The endless belt 11 having such a thickness is less susceptible to thermal damage and thermal deformation, and its movement stability also is high. The width of the endless belt 11 is, for example, about 5 to 500 mm. The endless belt 11 having such a width is less susceptible to rupture, and its movement stability also is high. In addition, deposits are less likely to be formed on the inner surface of the endless belt 11, and the endless belt 11 does not occupy an excessively large space in the vacuum chamber 22.

A meandering detection sensor and a correction mechanism may be provided to prevent the meandering of the endless belt 11. The meandering of the endless belt 11 also can be prevented by forming a groove for defining the moving course in any of the rollers 12 to 14 or using expanding rollers or crown rollers as the rollers 12 to 14.

The moving path of the endless belt 11 has a forward path and a return path located adjacent to each other in proximity to the film forming position 46. That is, the positions of the rollers 12 to 14 are adjusted so that the forward path and the return path of the endless belt 11 are formed between the film forming position 46 and the film forming source 27. More specifically, the forward and return paths of the moving path of the endless belt 11 are formed between the film forming position 46 and the fixed shielding plate 35. The endless belt 11 has, in the position for shielding the substrate 21, a forward path portion 11a that occupies the forward path and a return path portion 11b that occupies the return path. Therefore, the substrate 21 that passes through the film forming position 46 is shielded doubly by the endless belt 11. In the present description, the path located closer to the film forming source 27 is defined as a forward path, and the path located closer to the substrate 21 is defined as a return path, respectively, with respect to the driving roller 12.

When the forward and return paths of the moving path of the endless belt 11 are formed in proximity to the film forming position 46, the following effects are obtained. During the film formation process, the forward path portion 11a of the endless belt 11 shields the surface of the substrate 21 to prevent the deposition of the material particles on the area other than the film forming area DA, and receives the radiant heat from the film forming source 27. The material particles are less likely to be deposited on the return path portion 11b of the endless belt 11, and the radiant heat also is less likely to reach the return path portion 11b. That is, the forward path portion 11a protects the return path portion 11b from heat. As a result, the return path portion 11b can define the film forming area DA and the incident angle range accurately. In addition, the substrate 21 can be prevented from being deformed due to the radiant heat from the film forming source 27.

More specifically, the forward path portion 11a and the return path portion 11b are parallel to each other in the thickness direction of the endless belt 11. Such a positional relationship ensures the above-mentioned effects more reliably.

The gap between the substrate 21 and the return path portion 11b is determined appropriately according to the conditions such as a film forming area, an incident angle range, a required definition accuracy, a film forming material, and a film forming rate. The minimum gap between the substrate 21 and the return path portion 11b is, for example, 0.5 to 10 mm. When the minimum gap is in this range, the contact between the substrate 21 and the return path portion 11b can be prevented while the required definition accuracy of the film forming area and the incident angle range is increased sufficiently. The same holds true for the gap between the forward path portion 11a and the return path portion 11b. The minimum gap between the forward path portion 11a and the return path portion 11b is, for example, 2 to 20 mm. When the minimum gap is in this range, it is possible to prevent the material particles from the film forming source 27 from coming into the inner surface of the endless belt 11 and being deposited thereon, or to prevent the film forming area and the incident angle range from changing due to the contact between the forward path portion 11a and the return path portion 11b.

As described with reference to FIG. 2A, in the present embodiment, the masks for defining the rectangular film forming area DA are the fixed shielding plate 35 and the endless belts 11 of the movable shielding mechanism 36. As shown in FIG. 2B, however, all the masks may be the endless belts 11 of the movable shielding mechanism 36. The former configuration is advantageous in terms of the cost of the apparatus. The latter configuration allows the film forming area DA and the incident angle range to be defined more accurately.

The timing for moving the endless belt 11 is not particularly limited. Preferably, the step of moving the endless belt 11 is carried out while the step of depositing the material 27b on the substrate 21 (depositing step) is carried out. For example, when the endless belt 11 is moved slowly at a constant speed, the material 27b is deposited uniformly all over the endless belt 11. This is effective in maintaining the film forming area DA constant over a long period of time. The same effect can be obtained when the endless belt 11 is moved intermittently according to a predetermined time schedule.

The movable shielding mechanism 36 may be provided with a cleaner for removing the deposit on the endless belt 11 while maintaining the vacuum. The endless belt 11 always can be maintained clean by removing the deposit on the endless belt 11. As a result, the film forming area DA and the incident angle range can be maintained constant over a longer period of time. Furthermore, if the deposit is scraped off the endless belt 11 intentionally, the deposit is prevented from falling off the endless belt 11 on its own. As a result, it is possible to prevent a sudden change in the film forming conditions or the formation of splashes due to the falling of the deposit on the film forming source 27.

The step of removing the deposit by the cleaner may be carried out in the process of manufacturing thin films. That is, the removing step can be carried out while the step of depositing the material 27b on the substrate 22 is carried out. This is of significance in the long-time film formation process. It also is efficient to carry out the removing step while moving the endless belt 11. Preferably, the removing step is carried out while the step of depositing the material 27b on the substrate 21 and the step of moving the endless belt 11 are carried out. The depositing step may be interrupted to carry out only the removing step, or the step of moving the endless belt 11 and the removing step may be carried out alternately.

The removing step may be carried out on an arbitrary portion of the endless belt 11 by the time when the arbitrary portion of the endless belt 11 reaches the return path in the position for shielding the substrate 21 after the arbitrary portion passes through the forward path in the position for shielding the substrate 21. This allows the return path portion 11b to be maintained clean, and therefore allows the film forming area DA and the incident angle range to be defined more accurately.

The cleaner may be provided in a position where the deposit can be removed from a portion of the endless belt 11 that is located away from the position for shielding the substrate 21. This is because the removed deposit is prevented from adhering to the substrate 21 or from falling toward the film forming source 27. In the present embodiment, the cleaner is disposed opposite to the driving roller 12 with the substrate 21 interposed therebetween.

Specifically, as the cleaner, (i) a tool for applying a mechanical force to the deposit on the endless belt 11, (ii) a tool for bending the endless belt 11, (iii) a heating source for heating the deposit on the endless belt 11, or (iv) a laser irradiation apparatus for irradiating the deposit on the endless belt 11 with laser light can be used. A combination of two or more selected from the above (i) to (iv) also can be used.

As shown in FIG. 3A, an example of the tool for applying a mechanical force to the deposit 11 is a blade (scraper) 15. The blade 15 is brought into contact with the endless belt 11 to scrape off the deposit. A recovery container 18 for collecting the deposits 4 scraped from the endless belt 11 is placed below the blade 15. The deposits collected in the recovery container 18 may be reused as the film forming material. The collection of the deposits in the recovery container 18 prevents the scattering of the deposits in the vacuum chamber 22, and also facilitates the cleaning operation.

The position of the blade 15 is adjusted so that the tip of the blade 15 touches slightly the endless belt 11 in a state where no deposit is formed on the endless belt 11. The position of the blade 15 may be adjusted so that a very small gap is formed between the blade 15 and the endless belt 11. When the position of the blade 15 is adjusted in such a manner, the blade 15 can remove the deposits reliably without damaging the endless belt 11. An actuator for adjusting the position of the blade 15 may be provided. The blade 15 also can be vibrated by the actuator to enhance the effect of removing the deposits. Examples of the material of the blade 15 include metals such as stainless steel, titanium, and hardened steel. Harder materials such as sapphire glass and ceramic also can be used instead of metals.

As shown in FIG. 3A, an example of the tool for bending the endless belt 11 is a small diameter roller 16 provided on the moving path of the endless belt 11. The endless belt 11 is wound around the small diameter roller 16, which bends the endless belt 11 strongly. If a particular section for applying a strong bending force to the endless belt 11 is provided in the moving path, as mentioned above, the deposits fall off easily in this particular section.

The bending force applied to the endless belt 11 by the small diameter roller 16 is stronger than that applied to the endless belt 11 by the other transfer rollers 12 to 14. A strong bending force produces great stress in the deposit on the endless belt 11, and as a result the deposit falls off the endless belt 11 on its own. The diameter of the small diameter roller 16 is adjusted to be smaller than the diameters of the other rollers 12 to 14, that is, to be small enough to apply to the endless belt 11 the bending force required to make the deposit fall off. For example, the diameter of the small diameter roller 16 is 30 to 70% of the diameters of the rollers 12 to 14. The winding angle of the endless belt 11 with respect to the small diameter roller 16 may be adjusted to be equal to or larger than (for example, 1 to 4 times) that of the endless belt 11 with respect to each of the rollers 12 to 14. The small diameter roller 16 may be a freely rotatable roller or a motor-driven roller.

One small diameter roller 16 may be provided, but when a plurality of small diameter rollers 16 are used to bend the endless belt 11 in different directions alternately, as in the present embodiment, the deposit falls off more easily. Furthermore, in the present embodiment, two methods are used in combination: a method of using the blade 15 to scrape the deposit and a method of using the small diameter roller 16 to bend the endless belt 11. When these methods are used in combination, the small diameter roller 12 provided on the upstream side of the moving path can separate the deposit from the endless belt 11, and the blade 15 provided on the downstream side can scrape the separated deposits. As a result, the deposit can be removed from the endless belt 11 more reliably.

If a release agent is applied previously to the endless belt 11, the bonding strength between the endless belt 11 and the deposit is reduced, and therefore the deposit can fall off the endless belt 11 more easily. The release agent is effective particularly in removing the deposit by the method of applying a mechanical force or the method of bending the endless belt 11. As the release agent, for example, a silicon release agent can be used.

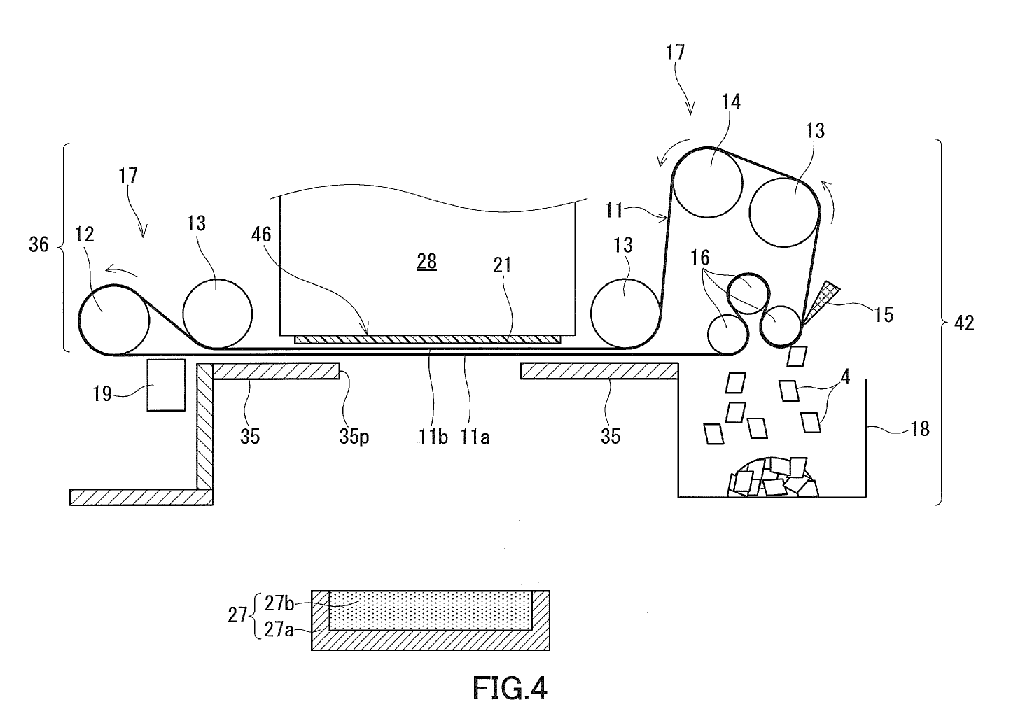

During the thin film manufacturing process, the endless belt 11 moves along the determined moving path repeatedly. With the repeated movement of the endless belt 11, the deposition of the material 27b on the endless bell 11 and the removal of the deposit are repeated. As a result, the release agent on the endless belt 11 also decreases gradually. Therefore, it is effective to add the release agent onto the endless belt 11 in a vacuum. In the example shown in FIG. 4, an apparatus 19 for feeding the release agent to the endless belt 11 is provided adjacent to the moving path of the endless belt 11. The feeding apparatus 19 can add the release agent to the endless belt 11 while the film formation on the substrate 21 is carried out. Specific examples of the feeding apparatus 19 are an apparatus for applying the release agent to the endless belt 11 and an apparatus for vapor depositing the release agent on the endless belt 11.

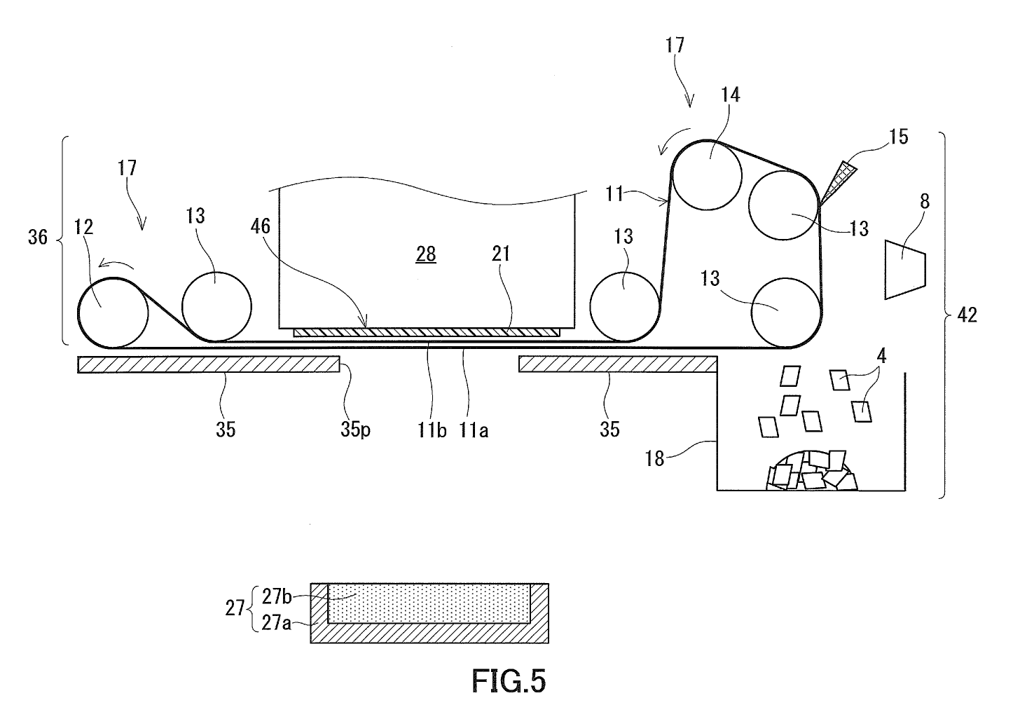

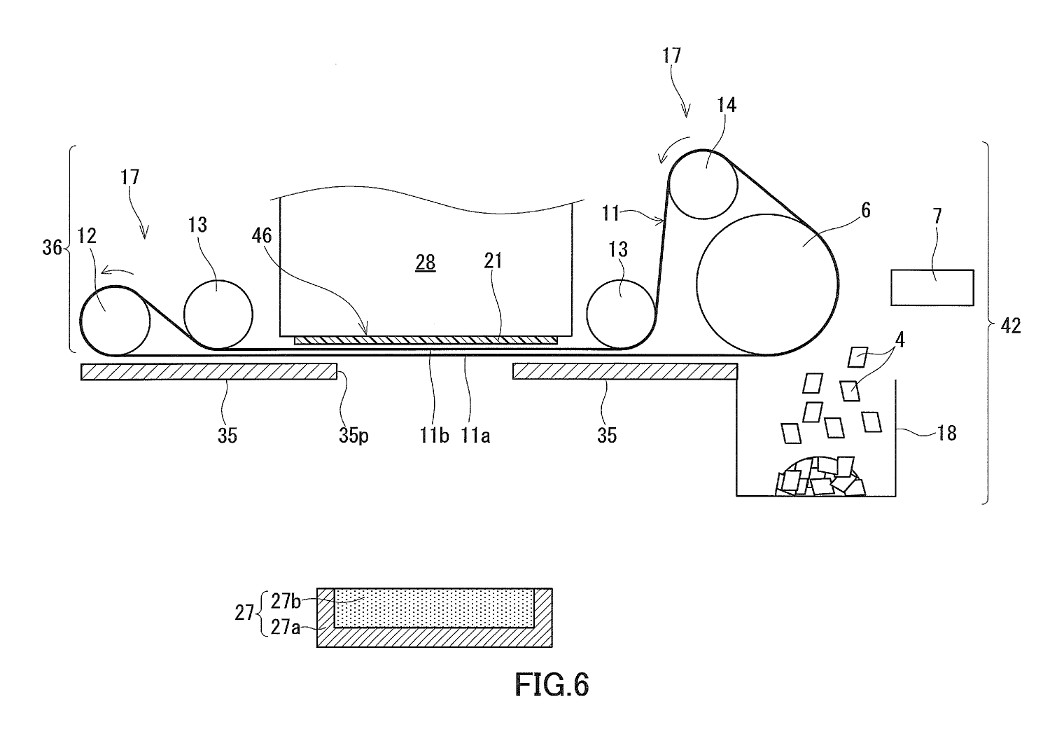

As shown in FIG. 5, a heating apparatus 8 for heating the deposit on the endless belt 11 may be provided adjacent to the moving path of the endless belt 11. The heating apparatus 8 heats the endless belt 11 to evaporate or pyrolytically decompose the deposit on the endless belt 11. Thus the deposit is removed. This method can be employed according to the heat resistance of the endless belt 11 and the characteristics of the deposit. Specifically, if the endless belt 11 is not thermally damaged at a temperature at which the deposit is evaporated or pyrolytically decomposed, this method can be employed.

In some cases, however, it is only necessary to reduce the bonding strength between the endless belt 11 and the deposit by heating. For example, when a melting release agent made of an organic compound is used, the release agent is melted by heating at a relatively low temperature, which allows the deposit to fall off. This method has an advantage in that the thermal damage of the endless belt 11 is less likely to occur. It is more effective to scrape the deposit by the blade 15 while reducing the bonding strength between the endless belt 11 and the deposit by heating, as shown in FIG. 5.

The heating apparatus 8 may be a contact type heating apparatus that contacts the endless belt 11 to transfer the heat directly thereto, or a non-contact type heating apparatus that irradiates the endless belt 11 with a heat ray or an electron beam. A specific example of the former heating apparatus is a heating roller, and specific examples of the latter heating apparatus are an infrared irradiation apparatus, a halogen lamp, and an electron beam irradiation apparatus.

As shown in FIG. 6, a laser irradiation apparatus 7 for irradiating the deposit on the endless belt 11 with laser light may be provided adjacent to the moving path of the endless belt 11. As in the heating method, the laser method is effective when the deposit can be evaporated or decomposed by laser irradiation. It is preferable to use, as the laser irradiation apparatus 7, an apparatus capable of emitting laser light with a wavelength that can be absorbed easily by the deposit and absorbed poorly by the endless belt 11. For example, when a silicon oxide is deposited on the stainless steel endless belt 11, a carbon dioxide gas laser can be used.

The endless belt 11 may be irradiated with laser light during the movement of the endless belt 11 along a laser treatment roller 6. From the viewpoint of preventing the deformation of the endless belt 11, it is desirable to irradiate the endless belt 11 with laser light while cooling the laser treatment roller 6 by a water-cooling mechanism or the like.

(Modification)

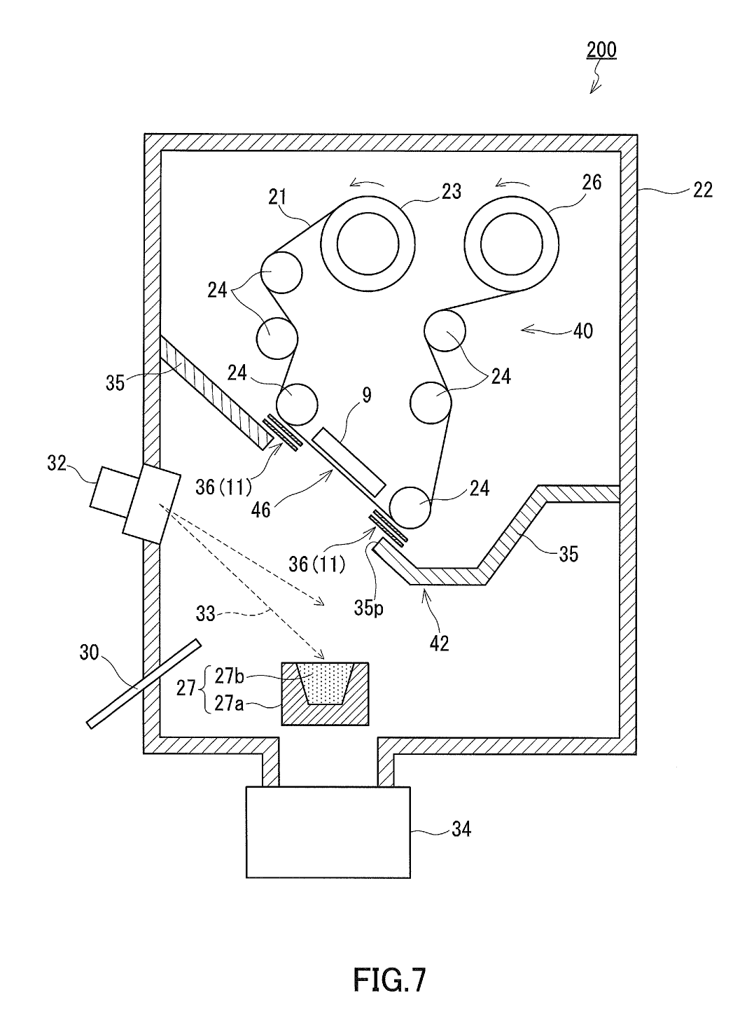

The basic configuration of a film forming apparatus 200 shown in FIG. 7 is the same as that of the film forming apparatus 100 shown in FIG. 1. The film forming apparatus 200 is different from the film forming apparatus 100 in that most of the material particles from the film forming source 27 are incident on the substrate 21 at oblique angles. More specifically, in the film forming apparatus 200, the material particles from the film forming source 27 are deposited on the substrate 21 that is moving linearly in the direction oblique with respect to the horizontal direction and the vertical direction (so-called oblique angle deposition). When a thin film is formed by oblique angle deposition, the resulting thin film has microvoids therein by a self-shadowing effect. Therefore, the oblique angle deposition is effective in manufacturing magnetic tapes with high C/N ratios and negative electrodes having excellent cycle characteristics.

Since the substrate 21 and the endless belt 11 are parallel to each other in the film forming apparatus 200, the gap between the substrate 21 and the endless belt 11 can be easily maintained constant. The lengthwise direction of the substrate 21 and the lengthwise direction of the endless belt 11 are orthogonal to each other at the position for shielding the substrate 21. The spaces for the rollers for moving the endless belt 11 and the cleaner for removing the deposit can be secured easily.

Furthermore, since the substrate 21 is not supported by the can, a mechanism 9 for cooling the substrate 21 may be provided separately. The cooling mechanism 9 is disposed, for example, behind the substrate 21. As the cooling mechanism 9, a cooling body that can be provided in contact with the substrate 21, a plurality of rollers, an apparatus for injecting a cooling gas toward the back surface of the substrate 21, or the like can be used.

In the film forming apparatus 200, movable shielding mechanisms 36 are provided at a position closer to the film forming source 27 and a position farther therefrom. During the oblique angle deposition, more deposits are formed on the mask located closer to the film forming source 27. Therefore, it is preferable to provide the movable shielding mechanism 36 at least at the position closer to the film forming source 27 with respect to the transfer direction of the substrate 21.

### INDUSTRIAL APPLICABILITY

The present invention can be applied to the manufacture of elongated electrode plates of energy storage devices. For example, a copper foil is used as the substrate 21, and silicon as the material 27b is placed in the carbon crucible 27a. Silicon is evaporated by the electron beam 33 to form a silicon film on the substrate 21. A thin film containing silicon and silicon oxide can be formed on the substrate 21 by introducing a trace amount of oxygen gas into the vacuum chamber 22. This thin film can be used for the negative electrode of a lithium ion secondary battery.

The present invention also is suitable for the manufacture of magnetic tapes. A polyethylene terephthalate film is used as the substrate 21, and cobalt as the material 27b is placed in the magnesia crucible 27a. Cobalt is evaporated by the electron beam 33 with oxygen gas being introduced into the vacuum chamber 22. As a result, a film containing cobalt is formed on the substrate 21.

The present invention can be applied not only to electrode plates of energy storage devices and magnetic tapes but also to capacitors, various sensors, solar cells, various optical films, moisture-proof films, and conductive films, which require a film formation process for the manufacture thereof. The present invention is effective particularly when films are formed for magnetic tapes, electrode plates of energy storage devices, capacitors, etc, which require long-time firm formation, formation of relatively thick films, and definition of incident angle ranges.

1. A method of forming a thin film by depositing, in a vacuum, particles emitted from a film forming source on a substrate, the method comprising a step of depositing the particles on the substrate in a state where a movable endless belt is disposed between the film forming source and the substrate so that a film forming area is defined on a surface of the substrate by the endless belt, whose moving path has a forward path and a return path that are formed between the film forming source and the substrate.

2. The thin film forming method according to claim 1, wherein
the endless belt has, in a position for shielding the substrate, a forward path portion that occupies the forward path and a return path portion that occupies the return path, and
the forward path portion and the return path portion are parallel to each other in a thickness direction of the endless belt.

3. The thin film forming method according to claim 1, further comprising a step of moving the endless belt so that a portion of the endless belt that defines the film forming area shifts from one to another.

4. The thin film forming method according to claim 3, wherein the step of moving the endless belt is carried out while the step of depositing the particles on the substrate is carried out.

5. The thin film forming method according to claim 4, further comprising a step of removing a deposit on the endless belt in a position away from a position for shielding the substrate,
wherein the step of removing the deposit is carried out while the step of depositing the particles and the step of moving the endless belt are carried out.

6. The thin film forming method according to claim 5, wherein in the step of removing the deposit, at least one selected from the group consisting of the following operations is performed: an operation of applying a mechanical force to the deposit on the endless belt; an operation of bending the endless belt; an operation of heating the deposit on the endless belt; and an operation of irradiating the deposit on the endless belt with laser light.

7. The thin film forming method according to claim 5, wherein when the forward path is located closer to the film forming source and the return path is located closer to the substrate, the step of removing the deposit is carried out on an arbitrary portion of the endless belt by the time when the arbitrary portion of the endless belt reaches the return path in the position for shielding the substrate after the arbitrary portion passes through the forward path in the position for shielding the substrate.

8. The thin film forming method according to claim 1, further comprising a step of removing a deposit on the endless belt in a position away from a position for shielding the substrate, while maintaining the vacuum.

9. The thin film forming method according to claim 1, wherein
the substrate is an elongated substrate having flexibility, and
the particles are deposited on the substrate that is being transferred from a feed roller to a take-up roller.

10. A film forming apparatus comprising:
a vacuum chamber;
a film forming source placed in the vacuum chamber;
a substrate transfer unit for feeding a substrate to a predetermined film forming position that faces the film forming source; and
a movable shielding mechanism having an endless belt for defining a film forming area on a surface of the substrate, and a driving section for moving the endless belt so that a portion of the endless belt that defines the film forming area shifts from one to another, the endless belt being placed in proximity to the film forming position so that a forward path and a return path of a moving path of the endless belt are formed between the film forming position and the film forming source.

11. The film forming apparatus according to claim 10, wherein
the endless belt has, in a position for shielding the substrate, a forward path portion that occupies the forward path and a return path portion that occupies the return path, and
the forward path portion and the return path portion are parallel to each other in a thickness direction of the endless belt.

12. The film forming apparatus according to claim 10, wherein the movable shielding mechanism further has a cleaner for removing a deposit on the endless belt while maintaining a vacuum.

13. The film forming apparatus according to claim 12, wherein the cleaner includes at least one selected from the group consisting of: a tool for applying a mechanical force to the deposit on the endless belt; a tool for bending the endless belt; a heating apparatus for heating the deposit on the endless belt; and a laser irradiation apparatus for irradiating the deposit on the endless belt with laser light.

14. The film forming apparatus according to claim 10, wherein
the substrate is an elongated substrate having flexibility, and
the substrate transfer unit has a first roller for feeding the substrate on which a film is to be formed, and a second roller for taking up the substrate on which the film has been formed.
